(19) United States
(12) Patent Application Publication
(10) Pub. No.: US 2025/0283500 A1
(43) Pub. Date: Sep. 11, 2025

(54) NUT

(71) Applicant: Kaoru TANEICHI, Kanagawa (JP)

(72) Inventor: Kaoru TANEICHI, Kanagawa (JP)

(21) Appl. No.: 19/032,933

(22) Filed: Jan. 21, 2025

(30) Foreign Application Priority Data
Mar. 5, 2024 (JP) 2024-32674

(51) Int. Cl. F16B 33/02; F16B 37/00

(52) U.S. Cl. CPC F16B 33/02; F16B 37/00

(57) ABSTRACT

A nut is configured by: a nut main body that has a plurality of nut segment housing portions; a plurality of nut segments that each have a female screw portion formed on an inner side thereof and are respectively housed in the plurality of nut segment housing portions; and a holding means for holding the plurality of nut segments so as not to fall from the nut segment housing portions.

### BACKGROUND OF THE INVENTION

### 1. Field of the Invention

The present invention relates to a nut that includes a plurality of nut segments.

### 2. Description of the Related Art

Conventionally, regarding a nut that engages with a bolt, the bolt cannot be screwed into the nut unless a minute clearance is provided between a screw thread of the bolt and a screw thread of the nut. This clearance is also a cause of loosening of the engaged state of the bolt and nut. To eliminate a minute clearance such as this and prevent loosening, a method in which, after the bolt and nut are tightened, a nut is further tightened in close contact with the nut to achieve a so-called double nut is commonly known.

Specifically, “a double nut in which two nuts of a same shape are stacked, the nuts having a female screw hole that engages with a male screw portion of a bolt on a center axis and configured to prevent falling from the bolt by the two nuts being stacked and each female screw hole being engaged with the male screw portion of the bolt, and one nut being retightened to be closer to the other nut, in which the double nut is characterized by: an annular projecting portion that projects in a direction along the center axis and extends in a circumferential direction around the center axis being provided on an opening circumferential edge on one side of the female screw hole; an annular stepped portion that recesses in a stepped-shape in the direction along the center axis and extends in the circumferential direction around the center axis being provided on an opening circumferential edge on the other side of the female screw hole; a center line of the annular projecting portion being offset by a distance D from the center axis of the female screw hole; the annular stepped portion having a shape corresponding to a shape of the annular projecting portion to enable fitting-engagement of the annular projecting portion in the direction along the center axis of the female screw hole; and a center line of the annular stepped portion being offset by the distance D from the center axis of the female screw hole” (Patent Literature 1) is known.

However, this nut requires use of a plurality of nuts, and each of the plurality of nuts requires tightening. Therefore, this nut has a disadvantage of being labor-intensive. In addition, because a plurality of nuts is used, a length of the bolt in an axial center direction becomes long and a larger space is required.
[Patent Literature 1] Japanese Patent Publication No. 6805466

In light of conventional disadvantages such as those described above, an object of the present invention is to provide a nut that is capable of preventing loosening simply by a single nut being tightened onto a bolt.

The object described above, other objects, and novel features of the present invention will become more completely clear when the following description is read with reference to the accompanying drawings.

However, the drawings are provided mainly for explanatory purposes and do not limit the technical scope of the present invention.

### SUMMARY OF THE INVENTION

To achieve the above-described object, a nut of the present invention according to a first aspect is configured by: a nut main body that has a plurality of nut segment housing portions; a plurality of nut segments that each have a female screw portion formed on an inner side thereof and are respectively housed in the plurality of nut segment housing portions; and a holding means for holding the plurality of nut segments so as not to fall from the nut segment housing portions. The nut is characterized by: the nut segment housing portion being configured by, from top down in a cross-sectional view, a substantially vertical inner wall portion, a sloped portion that is sloped in a direction in which a diameter decreases, and a substantially horizontal supporting portion that supports a bottom portion of the nut segment; the nut segment having a female screw portion formed on the inner side thereof and being configured on an outer side by, from top down in a cross-sectional view, a substantially vertical outer circumferential portion, a sliding portion that continues from a lower end portion of the outer circumferential portion, is formed at substantially a same angle as the sloped portion, and slides over the sloped portion when a bolt is inserted, and the bottom portion that continues from a lower end portion of the sliding portion and is supported by the supporting portion; when the bolt is inserted, the nut segment being capable of moving along the sloped portion in a direction in which an inner diameter of the plurality of nut segments increases; in a state in which the bottom portion of the nut segment is supported by the supporting portion, the female screw portion being formed to be in close contact with a male screw portion of the bolt; a movement restricting means for making the inner diameter of the female screw portion smaller than an outer diameter of the male screw portion of the bolt even when the nut segment moves in a radial direction being provided; and the angle of the sloped portion and the sliding portion being formed to be an angle substantially orthogonal to a surface on an upper portion side of the screw thread of the female screw portion.

The nut according to the first aspect characterized by the gap of a nut according to a second aspect having a length corresponding to 10% to 20% of a height of the screw thread of the female screw portion.

The supporting portion of the nut segment housing portion of the nut according to a third aspect is characterized by a step by which the screw thread of the nut segment continuously engages with a male screw of the bolt being formed.

### Effects of the Invention

As is clear from the descriptions above, effects listed as follows are achieved in the present invention.

(1) In the invention according to the first aspect, the plurality of nut segments is provided. When the bolt is inserted, the nut segments are capable of moving along the sloped portion in the direction in which the inner diameter increases. Therefore, even when the female screw portion is formed having dimensions by which the female screw portion and the screw thread of the male screw portion of the bolt are in close contact (clearance is not formed) in a state in which the nut segment is seated on the supporting portion, because the inner diameter of the nut segments increase, the bolt can be screwed into the female screw portion.

(2) The angle of the sloped portion and the sliding portion is formed to be an angle that is substantially orthogonal to a surface on an upper portion side of the screw thread of the female screw portion or the bolt. Therefore, when returning in a direction in which a radius decreases after moving in the direction in which the inner diameter of the plurality of nut segments increase, slide movement is possible while ensuring a state in which the surface on the upper portion side of the screw thread of the female screw portion and the bolt is in surface contact.

Therefore, when the nut segments are seated, the male screw portion and the female screw portion are integrated by being in close contact and clearance hardly being present, and act to prevent loosening.

(3) In the invention according to the second aspect as well, in addition to effects similar to (1) and (2) being achieved, the movement restricting means is provided to enable movement by a length corresponding to 10% to 20% of a height of the screw thread of the female screw portion. Therefore, tightening and the like can be more efficiently performed without the nut segments unnecessarily moving.

### BRIEF DESCRIPTION OF THE DRAWING

FIG. 1 to FIG. 8 are explanatory diagrams according to a first embodiment of the present invention.

FIG. 1 is a planar view of a nut according to a first embodiment;

FIG. 2 is a cross-sectional view of FIG. 1 taken along line 2-2;

FIG. 3 is an exploded perspective view of the nut according to the first embodiment;

FIG. 4 is a vertical cross-sectional view of a nut main body;

FIG. 5 is an explanatory diagram of a state in which nut segments are housed in nut segment housing portions;

FIG. 6 is an operation explanatory diagram of the nut segments when a bolt is inserted;

FIG. 7 is an operation explanatory diagram of the nut segments when the bolt is tightened; and

FIG. 8 is an explanatory diagram of a state after the bolt is tightened.

### EXPLANATION OF REFERENCE NUMBERS

1: nut
2: nut segment
3: nut segment housing portion
4: nut main body
5: female screw portion
6: holding means
7: partition wall
8: inner wall portion
9: sloped portion
10: supporting portion
11: outer circumferential portion
12: sliding portion
13: bottom portion
14: bolt
15: movement restricting means
16: bolt through-hole
17: cover body

### DETAILED DESCRIPTION OF THE PREFERRED EMBODIMENTS

The present invention will hereinafter be described in detail according to embodiments for carrying out the present invention shown in the drawings.

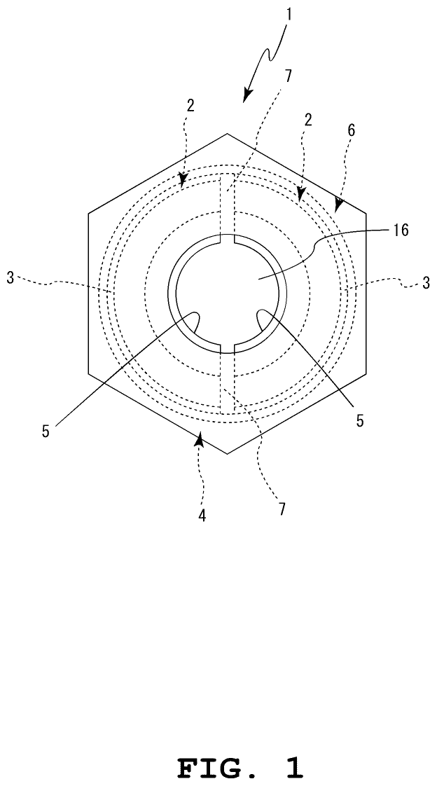

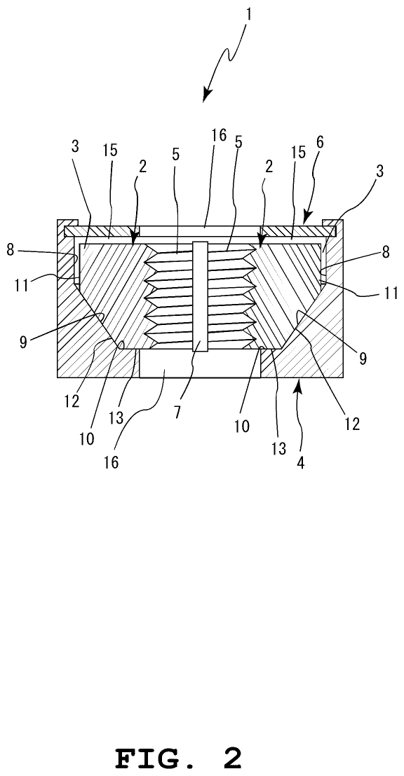

According to a first embodiment for carrying out the present invention shown in FIG. 1 to FIG. 8, reference number 1 denotes a nut including a plurality of nut segments 2 that move in a sliding manner in a direction in which an inner diameter expands.

As shown in FIG. 1 to FIG. 3, the nut 1 is configured by a nut main body 4 that has a plurality of nut segment housing portions 3, the plurality of nut segments 2 that each have a female screw portion 5 formed on an inner side thereof and are respectively housed in the plurality of nut segment housing portions 3, and a holding means 6 for holding the plurality of nut segments 2 so as not to fall from the nut segment housing portions 3.

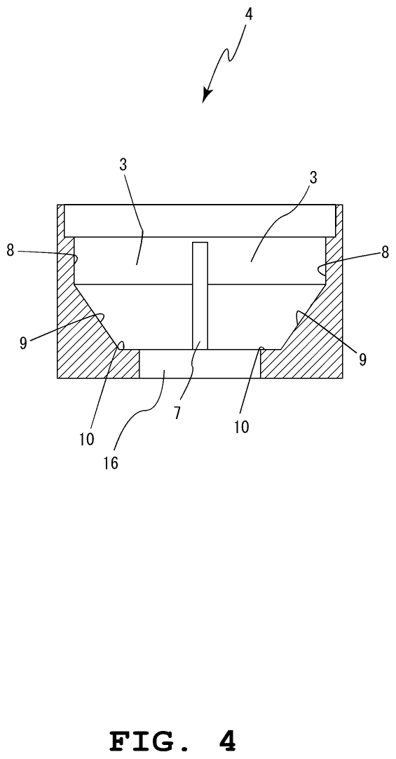

According to the present embodiment, the nut main body 4 is made of metal and formed such that a bolt can pass therethrough. As shown in FIG. 4, the nut main body 4 has a hexagonal shape from a planar view, and two nut segment housing portions 3 that are partitioned by a total of two partition walls 7 at a predetermined interval in a circumferential direction are formed inside the nut main body 4. Here, the nut main body 4 may be formed from a material such as resin. Three or more nut segment housing portions 3 may be formed. The shape of the nut main body 4 may be substantially polygonal, circular, or the like from a planar view.

From top down in a cross-sectional view, the nut segment housing portion 3 is configured by a substantially vertical inner wall portion 8, a sloped portion 9 that is sloped in a direction in which a diameter decreases, and a substantially horizontal supporting portion 10 that supports a bottom portion 13 of the nut segment 2. The nut segments 2 are respectively housed in the two nut segment housing portions 3.

From a planar view, the nut segment 2 is formed in a substantially semicircular shape, and the female screw portion 5 that engages with a screw thread of a male screw portion 14a of a bolt 14 is formed on an inner side (inner circumferential portion). A screw thread is formed in the female screw portion 5 such as to be in close contact (with little clearance) with the male screw portion 14a of the inserted bolt 14 in a state in which the nut segment 2 is seated on the supporting portion 10. From top down in the cross-sectional view, an outer side of the nut segment 2 is configured by a substantially vertical outer circumferential portion 11, a sliding portion 12 that continues from a lower end portion of the outer circumferential portion 11, is formed at substantially a same angle as the sloped portion 9, and slides over the sloped portion 9 when the bolt 14 is inserted, and the substantially horizontal bottom portion 13 that continues from a lower end portion of the sliding portion 12 and is supported by the supporting portion 10. As a result of the nut segments 2 and the nut segment housing portions 3 being configured in this manner, when the bolt 14 is inserted, the nut segments 2 are capable of moving along the sloped portions 9 in a direction in which an inner diameter of the female screw portions 5 of the plurality of nut segments 2 expands.

The nut segment 2 is formed such that the female screw portion 5 is in close contact with the male screw portion 14a of the bolt 14 in a state in which the bottom portion 13 is supported by the supporting portion 10, and a movement restricting means 15 for making the inner diameter of the female screw portions 5 smaller than an outer diameter of the male screw portion 14a of the bolt 14 even when the nut segments 2 move in a radial direction and the inner diameter of the female screw portions 5 widens to maximum is provided. According to the present embodiment, the movement restricting means 15 is a gap 15 that is formed such that, when the nut segments 2 slide over the sliding portions 12 and move obliquely upward, upper surfaces of the nut segments 2 come into contact with the holding means 6 and cannot move upward any further before the inner diameter of the female screw portions 5 of the nut segments 2 exceeds the outer diameter of the male screw portion 14a. As a result of such a configuration, the screw thread of the male screw portion 14a of the bolt 14 does not move beyond the female screw portions 5 when the bolt is inserted, and clearance between the screw thread of the female screw portions 5 and the screw thread of the male screw portion 14a of the bolt 14 that enable tightening can be ensured.

Here, a gap that makes the inner diameter of the female screw portions 5 smaller than the outer diameter of the male screw portion 14a of the bolt 14 even when the nut segments 2 move in the radial direction and the inner diameter of the female screw portions 5 widens to the maximum may be formed between the inner wall portion 8 and the outer circumferential portion 11, and used as the movement restricting means 15. In a case such as this, the inner wall portions 8 and the outer circumferential portions 11 come into contact and restrict movement of the nut segments 2 in the radial direction. Furthermore, the movement restricting means 15 may be such that the upper surfaces of the nut segments 2 come into contact with the holding means 6, and the inner wall portions 8 and the outer circumferential portions 11 come into contact and restrict movement of the nut segments 2 in the radial direction.

According to the present embodiment, the movement restricting means 15 that enables the nut segment 2 to move in the radial direction by only a length equivalent to 10% to 20% of a height of the screw thread of the female screw portion 5 or the screw thread of the bolt 14 is used. For example, when the height of the screw thread of the male screw portion 14a is 1.25 mm, a movable distance in the radial direction is restricted to about 0.125 mm to 0.25 mm by the movement restricting means 15. As a result of the movement restricting means 15 such as this being provided, engagement can be further facilitated, and the female screw portion 5 and the male screw portion 14a can be efficiently integrated during tightening.

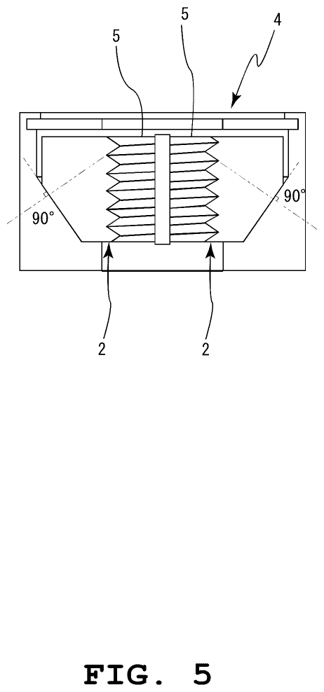

As shown in FIG. 5, the angle of the sloped portion 9 formed in the nut segment housing portion 3 and the sliding portion 11 of the nut segment 2 is formed to be an angle that is substantially orthogonal to a surface on an upper portion side of the screw thread of the female screw portion 5 or the male screw portion 14a of the bolt 14. Here, regarding the surface on the upper portion side of the screw thread, the angle is formed by the surface on the upper portion side and a horizontal line when the screw thread is bisected in a horizontal direction from an apex. For example, when the bolt 14 on which a metric thread is formed and the nut segment 2 having the female screw portion 5 that engages with the bolt 14 are used, the angle of the screw thread is about 60 degrees, and the angle formed by the surface of the upper portion side of the screw thread and the horizontal line is 30 degrees. Because the angle of the sloped portion 9 and the sliding portion 11 is formed to be substantially orthogonal to the surface of the upper portion side, the angle is 120 degrees (60 degrees when read from an acute angle side). As a result of the angle of the sloped portion 9 and the slide portion 11 being an angle such as, loosening is prevented by the nut segment 2 and the bolt 14 being integrated. Specifically, when the bolt 14 is inserted from a lower side of the nut main body 4, the nut segments 2 move to the outer side along the sloped portions 9 by being pressed by the bolt 14, and the inner diameter of the female screw portions 5 of the nut segments 2 slightly widen. As a result of the bolt 14 being tightened in this state, the bolt 14 or the nut main body 4 can be rotated and tightened in a state in which the clearance enabling the bolt 14 and the female screw portions 5 of the nut segments 2 to be engaged is ensured. When the bolt 14 is tightened to a certain extent, an object to be fastened is in a state of close contact. Subsequently, a surface on a lower side of the screw thread of the female screw portions 5 of the nut segments 2 is pressed by a surface of a lower side of the screw thread of the male screw portion 14a of the bolt 14, and the nut segments 2 move so as to slide downward along the sloped portion 9. When the bottom portions 12 of the nut segments 2 descend to come into contact with the supporting portion 10, the surface on the lower side of the screw thread of the female screw portions 5 of the nut segments 2 as well as the surface on the upper side come into close contact with the screw thread of the male screw portion 14a, and clearance is hardly present. As a result, loosening is prevented by the nut segment 2 and the bolt 14 being integrated.

Here, a guiding portion may be provided in the partition wall 7 dividing the nut segment housing portions 3 and a guided portion inserted into the guiding portion may be provided on both side surfaces of the nut segment 2. When such guiding portions and guided portions are formed, the guiding portions and the guided portions are preferably formed having the substantially same angle as the sloped portion 9 and the sliding portion 12. Here, in addition to a groove-like guiding portion being formed in the partition wall 7, a linear or band-like guiding portion may be formed in the partition wall 7 and a recessing guided portion may be formed in the nut segment 2.

A bolt through-hole 16 into which the bolt 14 is inserted is formed on a lower end portion side of the nut main body 4, and the holding means 6 is provided on an upper end portion side of the nut main body 4 such that the nut segments 2 do not fall from the nut segment housing portions 3.

Here, the supporting portion 10 is in a flat state according to the present embodiment. However, a step by which the female screw portions 5 of the nut segments 2 continuously engage with the male screw portion 14a of the bolt 14 may be formed in the supporting portions 10 of the nut segment housing portions 3. In such a case, the movement restricting means 15 may be provided by a step being provided in a cover body to correspond with the step, or the gap between the inner wall portion 8 and the outer circumferential portion 11 being a predetermined length. As a result of such a step being formed, even when the same nut segments 2 are used, the nut segments 2 can be connected such that the female screw portions 5 of the nut segments 2 continuously engage with the male screw portion of the bolt 14. Therefore, functions as a nut can be provided regardless of which nut segment 2 is housed in which nut segment housing portion 3. That is, because the same nut segments 2 can be used, the female screw portions 5 not being continuous due to assembly error and functions as a nut not being provided can be prevented. All that is required is that one type of nut segment be manufactured, and cost can be reduced.

According to the present embodiment, the holding means 6 is configured by a plate-shaped cover body 17 that is fixed near the upper end portion of the nut main body 4 by crimping, welding, bonding, or the like. The bolt through-hole 16 is formed in a center portion of the cover body 17. The movement restricting means 15 is formed by a predetermined gap being provided between a bottom portion of the cover body 17 and the upper surface of the nut segments 2.

Here, according to the present embodiment, the cover body 17 is provided in the upper end portion of the nut main body 4 by crimping. However, for example, the holding means 6 may be formed using a cover member that has a hexagonal outer diameter and is capable of being fixed to the nut main body 4 in a state of covering the outer peripheral portion and the upper portion of the nut main body 4. Such a cover member is fixed to the nut main body 4 by welding, locking, bonding, or the like. Here, other publicly known holding means 6 can be used as the holding means 6.

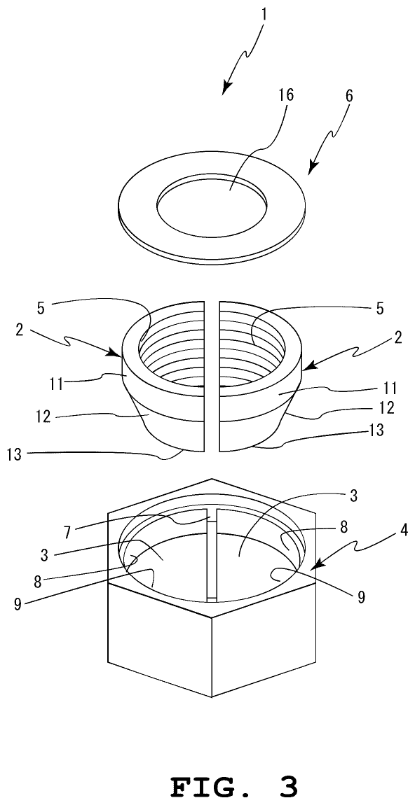

As shown in FIG. 3, for example, the partition wall 7 is formed into a substantially rectangular shape from a planar view and provided such as to oppose the inner side of the nut main body 4. Here, for example, the partition wall 7 may have any shape, such as a substantially fan-like shape, a trapezoid, or a triangle, as long as the shape enables both side portions of the nut segments 2 and the partition walls 7 to be substantially in contact at all times.

For example, the nut 1 of the present invention is used in wooden housing, steel structures, concrete structures, and the like. Here, in addition to the foregoing, the nut 1 can be used in various equipment such as space, aviation, and nautical equipment.

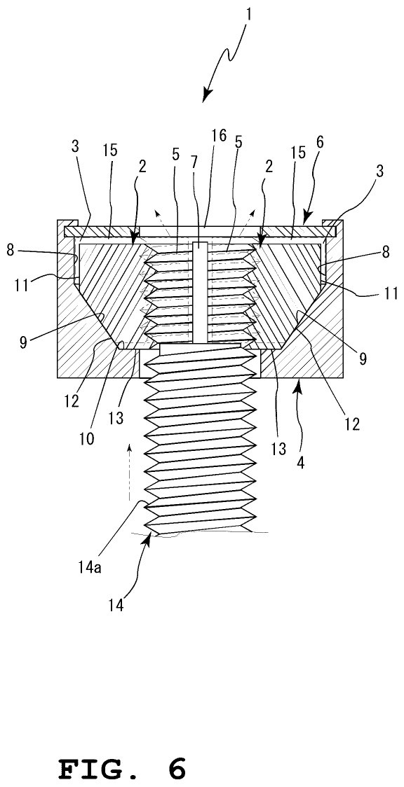

When the nut 1 is used, the bolt 14 is inserted into the bolt through-hole 16 from a lower side of the nut main body 4 and placed in contact with the bottom portion of the nut segments 2. Then, as shown in FIG. 6, a tip end portion of the bolt 14 presses the nut segments 2 housed in the nut segment housing portions 3 from below. The nut segments 2 move along the sloped portions 9 in the radial direction of the nut main body 4 and move in the radial direction until the bottom portion of the cover body 17 and the upper surface of the nut segments 2 come into contact.

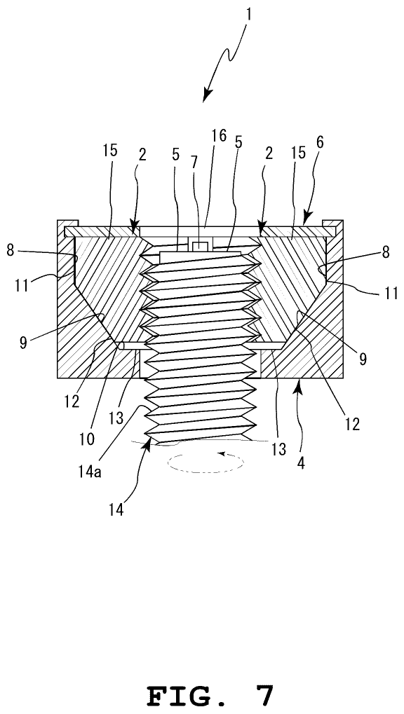

As a result of the nut segments 2 moving in this manner, as shown in FIG. 7, the clearance enabling engagement between the male screw portion 14a of the bolt 14 and the female screw portions 5 of the nut segments 2 is ensured, and the bolt 14 can be screwed into the female screw portions 5.

When the bolt 14 is tightened and objects to be fastened are in a state of contact with each other, should the bolt 14 be further tightened, the surface on the lower side of the screw thread of the female screw portions 5 of the nut segments 2 is pressed by the surface on the lower side of the screw thread of the male screw portion 14a of the bolt 14 and moves such as to slide downward along the sloped portions 9. When the nut is further tightened in this state, tightening is ended before the bottom portions 12 of the nut segments 2 comes into contact with the supporting portion 10, specifically, in a state in which a gap of about 0.1 mm is present between the bottom portions 12 of the nut segments 2 and the supporting portion 10.

Unless the bolt is subsequently rotated, the nut segment 2 slides downward along the sloped portion 9 and is fixed by crimping.

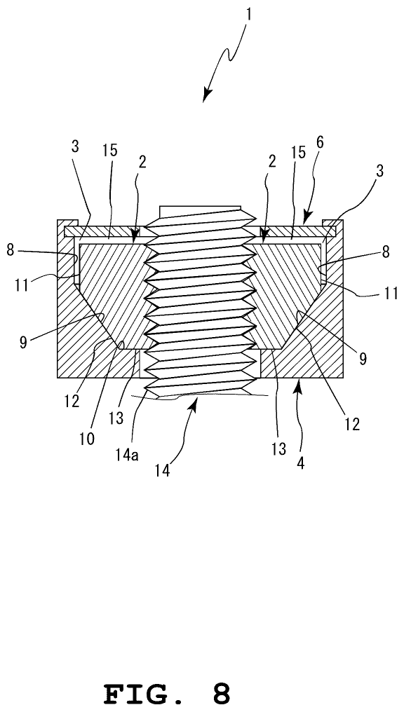

That is, when the bottom portions 12 of the nut segments 2 descend to come into contact with the supporting portion 10, as shown in FIG. 8, the screw thread of the male screw portion 14a comes into close contact not only with the surface on the lower side of the screw thread of the female screw portions 5 of the nut segments 2 but also the surface on the upper side, and clearance is hardly present. As a result, the bolt 14 is unable to rotate, the nut segments 2 and the bolt 14 are integrated, and loosening is prevented. Here, a nut that does not have a washer is described. However, a washer that has a screw hole or claws may be provided. Other publicly known washers can also be used.

### INDUSTRIAL APPLICABILITY

The present invention is used in an industry in which nuts are manufactured.

According

What is claimed is:

1. A nut comprising:
a nut main body that has a plurality of nut segment housing portions;
a plurality of nut segments that each have a female screw portion formed on an inner side thereof and are respectively housed in the plurality of nut segment housing portions; and
a holding means for holding the plurality of nut segments so as not to fall from the nut segment housing portions, wherein
the nut segment housing portion is configured by, from top down in a cross-sectional view, a substantially vertical inner wall portion, a sloped portion that is sloped in a direction in which a diameter decreases, and a substantially horizontal supporting portion that supports a bottom portion of the nut segment,
the nut segment has a female screw portion formed on the inner side thereof and is configured on an outer side by, from top down in a cross-sectional view, a substantially vertical outer circumferential portion, a sliding portion that continues from a lower end portion of the outer circumferential portion, is formed at substantially a same angle as the sloped portion, and slides over the sloped portion when a bolt is inserted, and the bottom portion that continues from a lower end portion of the sliding portion and is supported by the supporting portion,
when the bolt is inserted, the nut segment is capable of moving along the sloped portion in a direction in which an inner diameter of the plurality of nut segments increases,
in a state in which the bottom portion of the nut segment is supported by the supporting portion, the female screw portion is formed to be in close contact with a male screw portion of the bolt,
a movement restricting means for making the inner diameter of the female screw portion smaller than an outer diameter of the male screw portion of the bolt even when the nut segment moves in a radial direction is provided, and
the angle of the sloped portion and the sliding portion is formed to be an angle substantially orthogonal to a surface on an upper portion side of the screw thread of the female screw portion.

2. The nut according to claim 1, characterized by:
the movement restricting means being that which restricts the nut segment to be moveable in the direction in which the inner diameter of the plurality of nut segments increase by a length corresponding to 10% to 20% of a height of the screw thread of the female screw portion.
